(19) United States
(12) Patent Application Publication
(10) Pub. No.: US 2004/0267589 A1
(43) Pub. Date: Dec. 30, 2004

(54) System and method for applying human resources to a project plan

(75) Inventor: Bruce Wallman, Princeton, NJ (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY (US)

(21) Appl. No.: 10/603,713

(22) Filed: Jun. 25, 2003

(51) Int. Cl. G06F 17/60

(52) U.S. Cl. 705/9

(57) ABSTRACT

A system and method for assigning human resources to tasks in a project plan. The system comprises: a database of people, wherein each person in the database includes an associated set of role capabilities; a plan analysis system that analyzes the project plan and determines all of the roles required for the project plan; a matching system which, for each role, identifies a subset of people from the database who are capable of fulfilling the role; a selection system which, for each role, selects at least one person from the identified subset of people to fulfill the role; and an allocation system that assigns people to a list of tasks for the project plan, wherein each task specifies at least one role, and each role specifies the at least one person selected to fulfill the role.

### BACKGROUND OF THE INVENTION

1. Technical Field

The present invention relates generally to project planning, and relates more specifically to a system and method for allocating human resources to tasks in a project plan.

2. Related Art

Presently there exist numerous automated project-planning tools, such as PERT schedulers that are used to schedule, organize, and coordinate tasks over the lifecycle of complex projects. In addition, project-planning tools typically provide a mechanism for specifying resources and quantities that are required to fulfill tasks. For instance, if a project includes a computer-programming task, the planning tool can be used to specify one or more programmers and the number of hours that are necessary to complete the task.

As the complexity of projects increase, the number of resources that must be specified to fulfill the requirements for all of the tasks increases. This can become particularly burdensome for a planner in the case where many different human resources, i.e., people, must be allocated to tasks. When allocating human resources, it is often the case that a task may include several roles, e.g., a project manager and a computer programmer. Thus, it is not unusual for a planner to have to account for hundreds or thousands of roles that are required throughout a project lifecycle.

Current technology requires the planner to manually assign people to roles within tasks, for instance using copy and paste operations. The result is a series of manual operations that can often take a planner one or more days to complete. Accordingly, a need exists for an automated system for assigning human resources to tasks within a planning tool.

### SUMMARY OF THE INVENTION

The present invention addresses the above-mentioned problems, as well as others, by providing an automated system for assigning human resources to tasks within a planning tool. In a first aspect, the invention provides a system for assigning human resources to tasks in a project plan, comprising: a database of people, wherein each person in the database includes an associated set of role capabilities; a plan analysis system that analyzes the project plan and determines all of the roles required for the project plan; a matching system which, for each role, identifies a subset of people from the database who are capable of fulfilling the role; a selection system which, for each role, selects at least one person from the identified subset of people to fulfill the role; and an allocation system that assigns people to a list of tasks for the project plan, wherein each task specifies at least one role, and each role specifies the at least one person selected to fulfill the role.

In a second aspect, the invention provides a method for assigning human resources to tasks in a project plan, comprising: providing a database of people, wherein each person in the database includes an associated set of role capabilities; analyzing the project plan to determine all of the roles required for the project plan; for each role, identifying a subset of people from the database who are capable of fulfilling the role; for each role, selecting at least one person from the identified subset of people to fulfill the role; and assigning people to a list of tasks for the project plan, wherein each task specifies at least one role, and each role specifies the at least one person selected to fulfill the role.

In a third aspect, the invention provides a program product stored on a recordable medium for assigning resources to tasks in a project plan, comprising: means for analyzing the project plan to determine all of the roles required for the project plan; means for identifying a subset of resources for each role, wherein each resource in a given subset is capable of fulfilling the associated role; means for selecting at least one resource from each subset of resources to fulfill the associated role; and means for assigning resources to a list of tasks for the project plan, wherein each task specifies at least one role, and each role specifies the at least one resource selected to fulfill the role.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a human resources assignment system for in accordance with the present invention.

FIG. 2 depicts a selection interface for selecting people for roles in accordance with the present invention.

FIG. 3 depicts a task list with people allocations in accordance with the present invention.

### DETAILED DESCRIPTION OF THE INVENTION

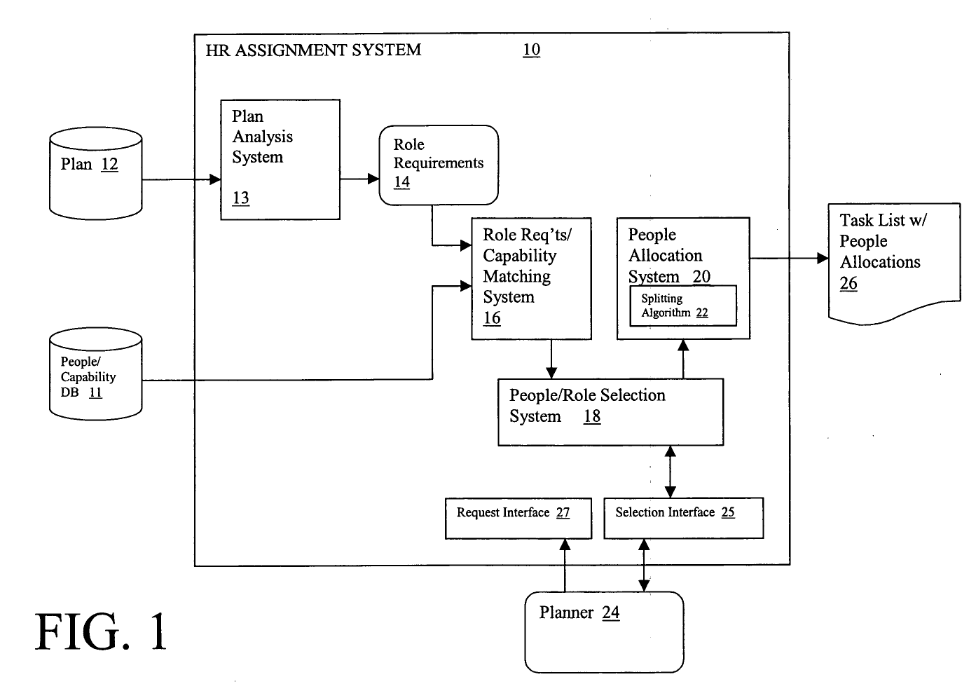

Referring now to the drawings, FIG. 1 depicts a human resources (HR) assignment system 10 for assigning individual people to tasks in a project plan 12. HR assignment system 10 may be implemented as a software product that can be stored in memory and be executed on any type of computer system. In an exemplary embodiment, HR assignment system 10 may comprise a graphical user interface that provides a user-friendly environment for a planner 24. In another embodiment, HR assignment system 10 could be integrated into a planning system, such as a PERT scheduler. Moreover, while the invention is described with reference to assigning human resources to tasks, it should be understood that the invention could be used to assign any type of resource, e.g., IT, hardware, software, etc., to a task in a planning environment.

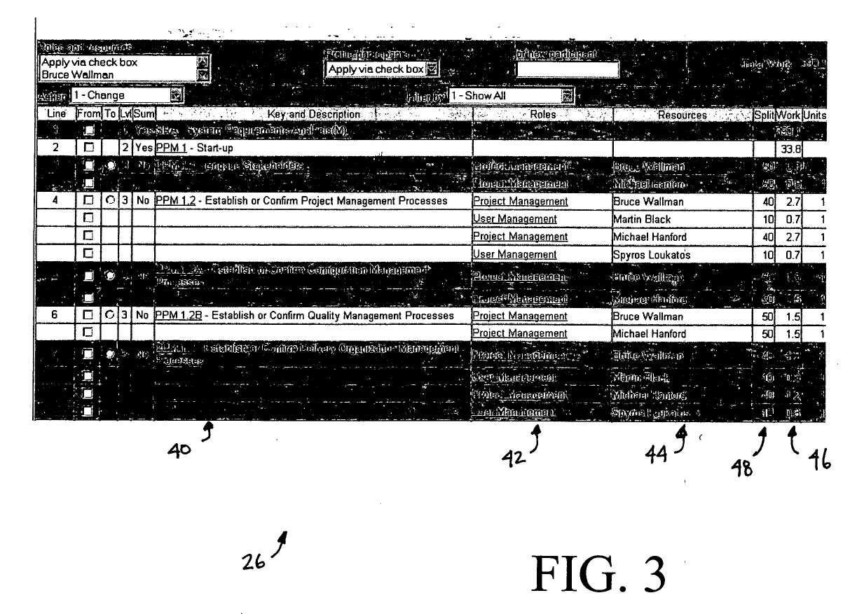

Project plan 12 may take any form, but generally comprises a stored list of tasks, with each task including one or more roles. A task can represent any activity that is to be performed as part of the project plan 12, and tasks can be grouped together, e.g., into phases. A role is a specific job necessary to help fulfill one or more tasks. Often, a task may require multiple roles. For instance, in FIG. 3, an exemplary task is shown entitled, “Establish or Confirm Project Management Processes,” which includes a 3.5-hour Project Management role and a 3.5-hour User Management role. Human resource assignment system 10 provides an automated mechanism for assigning people to roles for each task within the project plan 12.

To implement the invention, a people/capability database 11 is provided that includes a list of the people affiliated with or available to an organization, and a set of capabilities for each of the people. The capabilities may include, e.g., any roles the individual is capable of performing, the geographic location of the person, the division in the organization to which the person belongs, and/or any other relevant attributes. Data can be entered and updated into people/capability database 11 in any manner, e.g., from an electronic form accessible by all of the people affiliated with the organization, via any form of load process, etc. Moreover, database 11 can take any form and be stored in any manner, e.g., as a file, as a relational database, as a data object, etc.

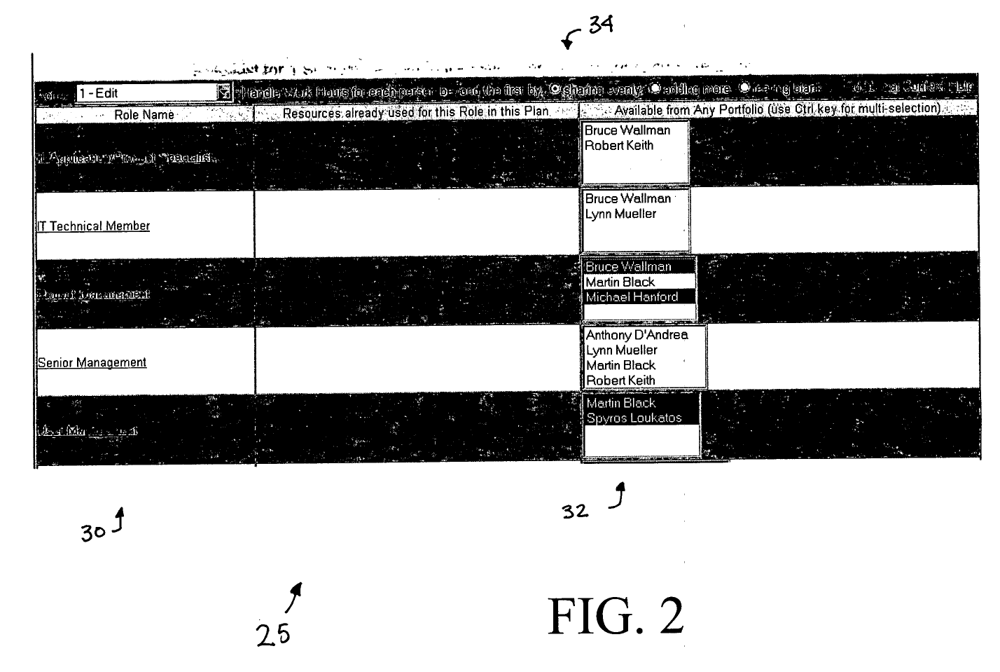

When a planner 24 requires the assignment of people to tasks, the planner 24 enters a request, e.g., via a request interface 27, for an allocation of resources across a set of project tasks within project plan 12. For the first step in the process, plan analysis system 13 analyzes project plan 12 to determine all of the role requirements 14 for the project plan 12 (e.g., project manager, user manager, IT specialist, programmer, etc.). Once all of the role requirements 14 are determined, role requirement/capability matching system 16 identifies the subset of people from database 11 that can fulfill each role. Thus, for each role, a unique subset of people is identified from database 11 as having the capabilities to fulfill the particular role. For instance, matching system 16 may identify John Doe, Joe Smith, and Fred Jones, as people who are capable of fulfilling a project management role; Jane Johnson and Bill Adams as people capable of fulfilling a user manager role; etc. The resulting matches or subsets of people are utilized by people/role selection system 18 to allow planner 24 to select, via selection interface 25, what people are to fulfill which roles. An example of such a selection interface 25 is shown in FIG. 2.

The exemplary selection interface 25 shown in FIG. 2 includes a list of all the roles 30 for project plan 12 identified by plan analysis system 13. Each role 30 includes an associated subset of people 32 capable of fulfilling the particular role. In the example shown, the list of roles 30 includes: IT Application/Product Specialist; IT Technical Member; Project Management; Senior Management; and User Management. For the role “IT Application/Product Specialist,” the associated subset is made up of two people, Bruce Wallman and Robert Keith, who were identified as capable of fulfilling the role. For the role “IT Technical Member,” Bruce Wallman and Lynn Mueller make up the subset of people having the capability of performing the role. From this interface 25, the planner 24 can select one or more people to fulfill each role, e.g., by clicking on a name or names. For instance, for the Project Management role, the planner 24 has selected Bruce Wallman and Michael Hanford (shown highlighted). For the User Management Role, the planner 24 has selected Martin Black and Spyros Loukatos (also shown highlighted). The people selected by the planner 24 will be assigned to fulfill the associated role for each task requiring the role in the project plan 12.

In addition, selection interface 25 allows the planner 24 to select how the role should be split among people selected for a given same role, i.e., how the time should be allocated among the selected people. For instance, planner 24 can select a button 34 that requests that by default all of the selected people share the work evenly, or a button that adds equal increments of work for each resource beyond the first added to the same role.

Once the selections are made, the information is passed to people allocation system 20. People allocation system 20 assigns people to roles at the task level based on the selections made by the planner 24. In addition, where multiple people are selected to perform the same role, time allocations are made amongst people performing the identical roles, i.e., roles for tasks are split amongst the selected people. Splitting algorithm 22 determines how time is to be allocated among multiple people performing the same role. The results are outputted as a task list w/people allocations 26.

An example of a task list w/people allocations 26 for the selections made in FIG. 2 is shown in FIG. 3. Namely, FIG. 3 shows a partial task listing 40 depicting seven tasks, with each task including one or more roles 42. Also included is the resource (i.e., person) 44 assigned to fulfill each role, the number of hours 46 required for each role, and the relative split 48 created for people performing roles for a given task.

Accordingly, for the third task “Engage Stakeholders,” it can be seen that the role of project management has been split between Bruce Wallman and Michael Hanford, in this case 50-50. For the fourth task “Establish or Confirm Project Management Processes,” it can be seen that the role of project management has again been split by Bruce Wallman and Michael Hanford, and the role of User Management has been split by Martin Black and Spyros Loukatos. Thus, when a role (e.g., project management) is required for more than one task, people allocation system 20 assigns the selected person or persons to fulfill the role for each task. Moreover, when multiple people are selected for a role, people allocation system 20 splits the role at the task level for each task. Accordingly, in the example shown in FIGS. 2 and 3, Bruce Wallman and Michael Hanford have been assigned to each task requiring Project Management (i.e., tasks 3, 4, 5, 6 and 7). Similarly, Martin Black and Spyros Loukatos have been assigned to each task requiring User Management (i.e., tasks 4 and 7).

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A system for assigning human resources to tasks in a project plan, comprising:
a database of people, wherein each person in the database includes an associated set of role capabilities;
a plan analysis system that analyzes the project plan and determines all of the roles required for the project plan;
a matching system which, for each role, identifies a subset of people from the database who are capable of fulfilling the role;
a selection system which, for each role, selects at least one person from the identified subset of people to fulfill the role; and
an allocation system that assigns people to a list of tasks for the project plan, wherein each task specifies at least one role, and each role specifies the at least one person selected to fulfill the role.

2. The system of claim 1, wherein the selection system comprises a graphical user interface that allows a planner to select the at least one person.

3. The system of claim 1, wherein the selection system comprises a system for splitting roles when multiple people are selected to fulfill a single role.

4. The system of claim 3, wherein the roles are split based on time.

5. The system of claim 4, wherein by default, the roles are split equally among the multiple people selected to fulfill the single role.

6. The system of claim 1, wherein the matching system identifies the subset of people based on the role capabilities of the people in the database.

7. The system of claim 1, wherein each person in the database further includes an associated set of attributes selected from the group consisting of: geographic location and division within an organization.

8. A method for assigning human resources to tasks in a project plan, comprising:
providing a database of people, wherein each person in the database includes an associated set of role capabilities;
analyzing the project plan to determine all of the roles required for the project plan;
for each role, identifying a subset of people from the database who are capable of fulfilling the role;
for each role, selecting at least one person from the identified subset of people to fulfill the role; and
assigning people to a list of tasks for the project plan, wherein each task specifies at least one role, and each role specifies the at least one person selected to fulfill the role.

9. The method of claim 8, wherein the selection step is achieved via a graphical user interface by a planner to select the at least one person.

10. The method of claim 8, wherein the selection step comprises automatically splitting a single role among multiple people when multiple people are selected to fulfill the single role.

11. The method of claim 10, wherein the role is split based on time.

12. The method of claim 11, wherein by default, the role is split equally among the multiple people selected to fulfill the single role.

13. The method of claim 8, wherein the subset of people is identified based on the role capabilities of the people in the database.

14. The method of claim 13, wherein the subset of people is further identified based on attributes selected from the group consisting of: geographic location and division in the organization.

15. A program product stored on a recordable medium for assigning resources to tasks in a project plan, comprising:
means for analyzing the project plan to determine all of the roles required for the project plan;
means for identifying a subset of resources for each role, wherein each resource in a given subset is capable of fulfilling the associated role;
means for selecting at least one resource from each subset of resources to fulfill the associated role; and
means for assigning resources to a list of tasks for the project plan, wherein each task specifies at least one role, and each role specifies the at least one resource selected to fulfill the role.

16. The program product of claim 15, wherein the resources comprise human resources.

17. The program product of claim 16, further comprising means for splitting a role among multiple people when multiple people are selected to fulfill the role.

18. The program product of claim 17, wherein the splitting means allocates an amount of time to each of the multiple people.

19. The program product of claim 18, wherein the amount of time is split equally among all of the multiple people.

20. The program product of claim 18, wherein the amount of time split among the multiple people is determined based on an input from a planner.

21. The program product of claim 17, wherein the selecting means comprises a graphical user interface.
